(19) United States
(12) Patent Application Publication
(10) Pub. No.: US 2014/0043289 A1
(43) Pub. Date: Feb. 13, 2014

(54) CAPACITIVE SENSOR FOR A DIGITIZER SYSTEM

(71) Applicant: N-trig Ltd., Kfar-Saba (IL)

(72) Inventor: Yuval STERN, Kfar-Yona (IL)

(73) Assignee: N-trig Ltd., Kfar-Saba (IL)

(21) Appl. No.: 13/960,914

(22) Filed: Aug. 7, 2013

Related U.S. Application Data
(60) Provisional application No. 61/680,285, filed on Aug. 7, 2012.

(51) Int. Cl. G06F 3/044

(52) U.S. Cl. CPC G06F 3/044
USPC 345/174

(57) ABSTRACT

A pressure sensitive capacitive sensor for a digitizer system includes an interaction surface over which a user interacts with the capacitive sensor, at least one sensing layer operable to sense interaction by mutual capacitive sensing, the at least one sensing layer extending across the interaction surface, and an additional layer comprising resilient properties and operable to be locally compressed responsive to pressure locally applied on the interaction surface during user interaction with the capacitive sensor.

### RELATED APPLICATION

This application claims the benefit of priority under 35 USC §119(e) of U.S. Provisional Patent Application No. 61/680,285 filed Aug. 7, 2012, the contents of which is incorporated herein by reference in its entirety.

### FIELD AND BACKGROUND OF THE INVENTION

The present invention, in some embodiments thereof, relates to a capacitive sensor for a digitizer system and, more particularly, but not exclusively, to a mutual capacitance touch-screen.

Digitizer systems that include capacitive sensors are commonly used as input devices for a variety of Human Interface Devices (HIDs) and for a variety of different applications. A touch-screen is one type of digitizer system that is integrated with a Flat Panel Display (FPD). Touch-screens are often used for operating portable devices, such as laptop computers, tablet computers, MP3 players, smart phones and other devices.

Typically a digitizer system tracks free style input provided with a finger and/or stylus. Input can be provided by hovering over and/or touching the capacitive sensor of the system. In some known HIDs, input provided by a stylus while hovering over the capacitive sensor is interpreted as a pointing command, e.g. for positioning a cursor, while input provided by a stylus that is touching the capacitive sensor is interpreted as an input commands such as a mouse click command and/or inking command, e.g. for drawing. In some known systems, different pressure levels are tracked while a user provides touch and the tracked pressure is used to adjust line thickness displayed on an associated display screen, e.g. to display thicker lines while more pressure is applied and thinner lines while less pressure is applied.

A mutual capacitive sensor is one type of capacitive sensor that can be used with a digitizer system. Mutual capacitive sensors typically include a matrix formed with parallel conductive material arranged in rows and columns with a capacitive connection created around overlap and/or junction areas formed between rows and columns. Bringing a finger or conductive object close to the surface of the sensor changes the local electrostatic field and reduces the mutual capacitance between junction areas in the vicinity of the finger or conductive stylus. The capacitance change at junction points on the grid can be detected to determine location of the finger or conductive object on the capacitive sensor. The capacitance change is determined by applying a signal along one axis of the matrix and measuring the signal in the other axis. Mutual capacitance allows multi-touch operation where multiple fingers, palms or styli can be tracked at the same time.

FIG. 1 shows a block diagram of an exemplary digitizer system including a mutual capacitive sensor. Mutual capacitive sensor 26 of digitizer 100 includes a patterned arrangement of row conductive strips 21 and column conductive strips 18 arranged in a grid. Typically, row conductive strips 21 and column conductive strips 18 are electrically isolated from each other but have a capacitive connection in and/or around junction areas 42.

Optionally, capacitive sensor 26 is transparent so that it can be overlaid on a flat panel display (FPD). In transparent capacitive sensors, conductive strips 18 and 21 are formed with conductive transparent materials, or are thin enough so that they do not substantially interfere with viewing an electronic display placed behind conductive strips 18. Conductive strips 18 and 21 are typically patterned on a substrate of glass, Polyethylene terephthalate (PET) foil and/or other non-conductive substrate in one or more layers. Alternatively, conductive strips 18 may be patterned on one layer and conductive strips 21 may be patterned on another layer, wherein the two layers are isolated from one another.

During operation of digitizer system 100, digital unit 20 and/or ASIC 16 typically produce and send an interrogation signal or pulse to conductive strips along one axis, e.g. conductive strips 18 and sample output from the other axis, e.g., conductive strips 21. In some embodiments, the conductive strips along one axis are interrogated in a consecutive manner, and in response to each interrogation, output from the conductive strips on the other axis are sampled. This scanning procedure provides for obtaining output associated with each junction 42 of sensor 26. Typically, the interrogation and/or triggering signal is a series of pulses and/or any AC signal like a sinusoidal waveform. Typically, this procedure provides for detecting one or more conductive objects, e.g. fingertip 46 touching and/or hovering over sensor 26. More than one fingertip and/or other capacitive object, e.g. a token can be detected at the same time (multi-touch) based on this scanning procedure.

Typically, the sampled output is the interrogation signal that crossed at junctions 42 between row and column conductive strips due to mutual capacitance formed around junctions 42. Typically, base-line amplitude is detected in the absence of an object interacting with sensor 26. Typically, the presence of fingertip 46 decreases the amplitude of the coupled signal by 5-30%. Typically, presence of fingertip 46 produces a peak shaped location profile, e.g. a negative peak and/or trough with a base that generally covers and may extend around a contact area of fingertip 46 on touch sensor 26. Optionally, when fingertip 46 hovers over sensor 26, the location profile obtained is typically lower as compared to location profile obtained during touch.

Some known mutual capacitive sensors support both fingertip detection and detection of a signal transmitting stylus 44. Typically, a signal emitted by stylus 44 is detected by sensor 26 without requiring triggering conductive lines of the sensor with an interrogation signal. Typically, a signal emitted by stylus 44 is picked up by conductive lines close to a transmission point on stylus 44, e.g., close to a transmitting tip of stylus 44. Typically, amplitude of output sampled from conductive lines close to stylus 44 increases by 1-200%, depending on the stylus transmission power and the resistance of the input interface, e.g. sensor 26. Typically, a signal frequency of the signal transmitted by the stylus is selected to be differentiated from a signal frequency of the interrogation signal used to detect fingertip 46.

U.S. Pat. No. 7,372,455 entitled “Touch Detection for a Digitizer,” assigned to N-Trig Ltd., the content of which is incorporated herein by reference describes a digitizer system including a grid of sensing conductors extending over a sensing area, a source of oscillating electrical energy at a predetermined frequency, and detection circuitry for detecting a capacitive influence on the sensing conductors when said oscillating electrical energy is applied, the capacitive influence being interpreted as a touch, e.g. fingertip touch. The digitizer system is advantageous in that the same sensing conductors can be used both for fingertip touch sensing and for detection of an electromagnetic stylus. Another advantage is that the digitizer system can distinguish between more than one fingertip and/or more than one stylus interacting with the digitizer system at the same time.

Exemplary digitizer systems including capacitive sensors that detect stylus and/or finger touch location are also described in U.S. Pat. No. 6,690,156, U.S. Pat. No. 7,292,229 or U.S. Pat. No. 7,372,455, the full contents of which are all incorporated herein by reference.

U.S. Patent Application Publication No. 20100051356 entitled “Pressure Sensitive Stylus for a Digitizer” by N-Trig Ltd., the contents of which is incorporated by reference, describes a pressure sensitive stylus, comprising a movable tip that recedes within a housing of the stylus in response to user applied contact pressure, wherein a displacement of the tip along an axis on which it recedes is a function of the applied contact pressure, and an optical sensor enclosed within the housing for optically sensing the displacement of the tip and for providing output in response to the sensing.

U.S. Pat. No. 6,762,752 entitled “Dual Function Input Device and Method,” assigned to N-Trig Ltd., the content of which is incorporated herein by reference describes an apparatus for user input to a digital system, comprising a first sensing system for sensing a user interaction of a first type, co-located with a second sensing system for sensing a user interaction of a second type. The first system may detect styluses and like objects using EM radiation and the second system may detect touch pressure. The second system includes a first transparent foil having a first set of parallel pressure sensors and a second transparent foil, superimposed over the first transparent foil having a second set of parallel pressure sensors. The transparent foils are orientated such that the first and second sets of transparent foils are respectively orthogonal. A substantially non-conductive spacer is located between the first and second transparent foil to separate between the foils. The spacer is flexible to allow contact between pressure sensors on respective foils about a point of application of pressure, thereby to create electrical contact and transfer a signal between contacted pressure sensors. A scanning controller controls a scanning operation to apply signals to the sensors reading outputs in such a way so as to provide unambiguous pressure information concerning every junction on a grid defined by the pressure sensors.

### SUMMARY OF THE INVENTION

According to some embodiments of the present invention there is provided a capacitive sensor that includes a resilient, compressible, and/or resilient layer that is operable to locally deform responsive to touch by a finger and/or stylus interacting with the capacitive sensor. According to some embodiments of the present invention, a capacitive sensor is retrofitted with the resilient layer. According to some embodiments of the present invention, the resilient layer of the capacitive sensor is selected to improve the feel of a user interacting with the capacitive sensor, e.g. of a user writing on the capacitive sensor. Optionally, the resilient layer is selected to provide a feel of writing on a pad of paper as opposed to writing on a hard surface. According to some embodiments of the present invention, output of the capacitive sensor responsive to the local deformation is detected and used to track a pressure level applied by the finger, stylus and/or other object during interaction with the capacitive sensor.

According to an aspect of some embodiments of the present invention there is provided a pressure sensitive capacitive sensor for a digitizer system, the capacitive sensor comprising: an interaction surface over which a user interacts with the capacitive sensor; at least one sensing layer operable to sense interaction by mutual capacitive sensing, the at least one sensing layer extending across the interaction surface, wherein the at least one sensing layer is patterned with row and column sensing strips arranged in a grid; and an additional layer comprising resilient properties and operable to be locally compressed responsive to pressure locally applied on the interaction surface during user interaction with the capacitive sensor.

Optionally, the additional layer is selected to have a hardness of between 20-70 shore A.

Optionally, the additional layer is selected to have a thickness of between 50-500 μm.

Optionally, the additional layer is selected to have a thickness of between 100-300 μm.

Optionally, the sensor includes a protective layer, wherein the interaction surface is a surface of the protective layer, wherein the protective layer is formed from flexible material that is operable to bend responsive to pressure locally applied on the interaction surface.

Optionally, the sensor includes rigid layer, wherein the rigid layer is positioned distal from the interaction surface and wherein the additional layer is positioned between the rigid layer and the at least one sensing layer.

Optionally, the rigid layer is formed from a glass substrate.

Optionally, the sensor includes a reference layer, wherein the reference layer is conductive and is connected to ground or to a reference voltage.

Optionally, the additional layer is positioned between the at least one sensing layer and the reference layer.

Optionally, the additional layer is operative to provide for locally reducing distance between the at least one sensing layer and the reference layer around an interaction point, wherein the reducing is responsive to the applied pressure during the interaction.

Optionally, the capacitive sensor is configured for being overlaid on a flat panel display and wherein the additional layer is positioned between the at least one sensing layer and the flat panel display.

Optionally, the additional layer is operative to provide for locally reducing distance between the at least one sensing layer and the flat panel display around an interaction point, wherein the reducing is responsive to the applied pressure during the interaction.

Optionally, the at least one sensing layer is a single sensing layer and wherein the single sensing layer is formed with a flexible that is operable to bend responsive to pressure locally applied on the interaction surface.

Optionally, the single sensing layer includes row and column conductive strips patterned on a same surface of the single sensing layer.

Optionally, the single sensing layer includes row conductive strips patterned on a first surface of the single sensing layer and column conductive strips patterned on a second surface of the single sensing layer.

Optionally, the at least one sensing layer includes a first sensing layer patterned with row conductive strips and a second sensing layer patterned with column conductive strips and wherein the additional layer is positioned between the first sensing layer and the second sensing layer.

Optionally, at least one of the first and second sensing layers is formed with a flexible material and is operable to bend responsive to pressure locally applied on the interaction surface.

Optionally, the row conductive strips are patterned on a surface of the first sensing layer that faces a surface of the second sensing layer on which the column conductive strips are patterned.

Optionally, the additional layer is operative to provide for locally reducing distance between the first and second sensing layer, wherein the reducing is responsive to the applied pressure during the interaction.

Optionally, the at least sensing layer of the capacitive sensor is retrofitted with the additional layer.

Optionally, the additional layer is formed from a transparent material that is non-conductive.

According to an aspect of some embodiments of the present invention there is provided a digitizer system comprising a capacitive sensor as described herein above, and circuitry electrically connected to the capacitive sensor, wherein the circuitry is adapted for detecting output from the capacitive sensor and for determining both location of an interaction and pressure applied at the interaction location responsive to the output.

According to an aspect of some embodiments of the present invention there is provided a touch screen comprising: an interaction surface over which a user interacts with the touch screen; at least one sensing layer operable to sense interaction by mutual capacitive sensing, the at least one sensing layer extending across the interaction surface, wherein the at least one sensing layer is patterned with row and column sensing strips arranged in a grid; an additional layer comprising resilient properties and operable to be locally compressed responsive to pressure locally applied on the interaction surface; and a flat panel display.

Optionally, the additional layer is selected to have a hardness of between 20-70 shore A.

Optionally, the additional layer is selected to have a thickness of between 50-500 μm.

Optionally, the interaction surface is formed by a protective layer positioned over the at least one sensing layer, wherein the protective layer is formed from flexible material that is operable to bend to responsive to pressure locally applied on the interaction surface.

Optionally, the at least one sensing layer is a single sensing layer including row conductive strips patterned on a first surface of the single sensing layer and column conductive strips patterned on a second surface of the single sensing layer.

Optionally, the at least one sensing layer is a single sensing layer including row and column conductive strips patterned on a same surface of the single sensing layer.

Optionally, the additional layer is positioned between the at least one sensing layer and the flat panel display.

Optionally, the touch screen includes a reference layer, wherein the reference layer is conductive and is connected to ground or to a reference voltage and wherein the additional layer is positioned between the at least one sensing layer and the reference layer.

Optionally, the additional layer is operative to provide for locally reducing distance between the at least one sensing layer and the reference layer around an interaction point, wherein the reducing is responsive to the applied pressure during the interaction.

Optionally, the touch screen is retrofitted with the additional layer.

According to an aspect of some embodiments of the present invention there is provided a method for sensing applied pressure with a capacitive sensor that includes a resilient layer, the method comprising: scan output from a capacitive sensor; identify an interaction point; detect pressure profile around the interaction point; and determine pressure applied at the interaction point responsive to a feature of the detected pressure profile.

Optionally, the feature is a gradient of the pressure profile around the interaction point.

Optionally, the pressure profile is detected in a frequency band used to interrogate the capacitive sensor during scanning.

Optionally, the interaction point is responsive to touch by at least one of a fingertip and stylus.

Optionally, the pressure profile and the location of the interaction points are detected in a different time frame.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified block diagram of an exemplary digitizer system that is known in art;

FIGS. 2A and 2B and are simplified cross-sectional views of two exemplary touch-screens including an added resilient layer between sensing layers of an associated capacitive sensor, in accordance with some embodiments of the present invention;

FIGS. 3A, 3B and 3C are a simplified exploded view and two simplified cross-section views respectively of three exemplary touch-screens including an added resilient layer positioned between a capacitive sensor and an FPD of the touch-screen, in accordance with some embodiments of the present invention;

FIGS. 4A and 4B are simplified schematic illustrations of deformation due to fingertip touch in two exemplary touch-screens including an added resilient layer, in accordance with some embodiments of the present invention;

FIGS. 5A and 5B are simplified graphs showing exemplary output obtained from two capacitive sensors respectively in response to fingertip touch, in accordance with some embodiments of the present invention;

FIGS. 6A and 6B are simplified graphs showing exemplary output in two different frequency bands respectfully in response to touch with a signal transmitting stylus, in accordance with some embodiments of the present invention;

FIG. 7 is a simplified block diagram of an exemplary touch-screen, in accordance with some embodiments of the present invention; and

FIG. 8 is a simplified flow chart of an exemplary method for detecting pressure applied at interaction points on a mutual capacitive sensor, in accordance with some embodiments of the present invention.

### DESCRIPTION OF SPECIFIC EMBODIMENTS OF THE INVENTION

The present invention, in some embodiments thereof, relates to a capacitive sensor for a digitizer system and, more particularly, but not exclusively, to a mutual capacitive sensor.

Known capacitive sensors for digitizer systems have been typically designed to have a rigid construction to avoid local compression of any of the layers included in the capacitive sensor in response to a user applying pressure on the sensor during interaction. Typically, capacitive sensors have been designed to include a rigid layer, e.g. glass to prevent deformation of the sensor during interaction. Typically the rigid construction has been desired to provide stability of output and to localize the effect of touch by a finger and/or stylus. The present inventor has found that controlled local deformation of the capacitive sensor and/or controlled local compression of a layer of the capacitive sensor can be used to improve a user's experience while writing on the sensor without significantly affecting the stability of the output and/or the ability to localize the effect of touch by a finger and/or stylus. According to some embodiments of the present invention, an additional layer that is resilient and/or compressible is added to layers of a capacitive sensor to provide a desired feel. The present inventor has also found that when adding the additional layer to the capacitive sensor as described herein, an indication of a pressure level applied during touch can be determined from output of the capacitive sensor.

Known capacitive sensors for digitizer systems have typically been used to sense location of interaction but have not traditionally been used and/or relied upon to track pressure applied during interaction by touch. Typically, pressure applied on the capacitive sensor has been detected by sensing devices integrated in a stylus, e.g. as disclosed in incorporated U.S. Patent Application Publication No. 20100051356 or included as a separate sensing layer in the digitizer system, e.g. as disclosed in incorporated U.S. Pat. No. 6,762,752. These pressure sensing devices come along with additional components, complexity, power consumption and costs. In addition, when relying on a pressure sensitive stylus to sense applied pressure, information regarding pressure applied by a fingertip is not measured.

The present inventor has found a method for tracking pressure level of both a fingertip and stylus based on output sampled from a mutual capacitive sensor. According to some embodiments of the present invention, a compressible, resilient and/or resilient layer is added to the capacitive sensor to introduce deformation of at least one layer of the capacitive sensor responsive to applied pressure. In some embodiments of the present invention, the resilient layer is added between one or more layers carrying the row and column conductors and in addition to a rigid layer that is used to add rigidity to the sensor construction, e.g. a glass layer. In other embodiments of the present invention, the resilient layer is added between the capacitive sensor and an electronic display screen, e.g. a touch-screen, a layer connected to a reference potential and/or grounded. Typically, the layers between an interaction surface and the resilient layer are formed from flexible and/or pliable material so that the resilient layer can be locally compressed in response to applied pressure. According to some embodiments of the present invention, compression of the resilient layer in response to applied pressure alters the mutual capacitance in the region of touch and in nearby junctions of the capacitive sensor. In some exemplary embodiments, when a resilient layer is added between the row and column layers of the capacitive sensor, compression of the resilient layer due to applied pressure brings the row and column layer closer together around the region of touch. Typically, the increased proximity increases mutual capacitance between row and column conductors in the touch area which increases the amplitude of output detected in that region. Typically, a pressure profile obtained from output sampled from a capacitive sensor including a resilient layer between sensing layers is a peak generally centered with respect to the associated touch location.

Alternatively, when the resilient layer is added between the capacitive sensor and FPD, compression of the resilient layer in response to applied pressure brings the conductive strips, e.g. both row and column conductive strips closer to the FPD, e.g. to a ground layer and/or a layer connected to a reference voltage, thus increasing the load capacitance on the row and column conductive strips and reducing the steady state signal sampled. Typically, a pressure profile obtained from output sampled from a capacitive sensor including a resilient layer between the FPD and sensing layers is a trough and/or negative peak generally centered with respect to the associated touch location.

Typically, a pressure profile and/or output responsive to local compression of the resilient layer is a peak or trough generally surrounding an associated touch location, e.g. a two dimensional peak or trough spreading in both the row and column directions. Optionally, a pressure profile responsive to local compression of the resilient layer is shallower and wider spread as compared to a location profile. Typically, the spread pressure profile depends on the selected hardness of the resilient layer. As such the pressure profiles can typically be distinguished from the location profiles obtained responsive to presence of objects. According to some embodiments of the present invention, the height and/or width of the relatively shallow profile is used to determine a pressure level applied on the capacitive sensor, while a height and/or width of a relative steep profile is used to detect a location of interaction. Typically, the gradient of the pressure profile changes as the pressure applied on the capacitive sensor increases. Typically, the extent and amplitude of the location profile is not significantly altered by changes in the applied pressure.

In some exemplary embodiments, a resilience, thickness and/or hardness of the resilient layer is selected to obtain a desired spread of the pressure profile due to local compression of the resilient layer. Optionally, the resilience and thickness of the resilient layer is selected to provide a pressure profile that spreads over 6-20 conductive lines in each of the two axes of the sensor, although other ranges can be used depending on a size and resolution of the capacitive sensor and/or a desired resolution in detecting pressure levels. Optionally, the resilience, hardness and/or thickness of the resilient layer is selected to provide a pressure profile that is spread over 2-5 times as many conductive lines as a peak or trough responsive to a presence of an object, e.g. a fingertip touch.

In some exemplary embodiments, the resilient layer is a layer of silicone or gel. The resilient layer is formed from non-conductive material or isolating material. Optionally, the resilient layer is positioned between the row and column conductive lines and functions as a separation layer between the layers. Typically, for a harder resilient layer, lower amplitude compression that is spread over a larger area is obtained while softer layers result in more compression that is spread over a smaller area. Although a larger area makes it easier to detect pressure, the lower amplitude has the opposite effect. The localization of the pressure response is not only dependent on the properties of the resilient layer but is also typically dependent on the flexibility of the substrate carrying the conductive lines, the flexibility of the conductive lines and possibly other factors.

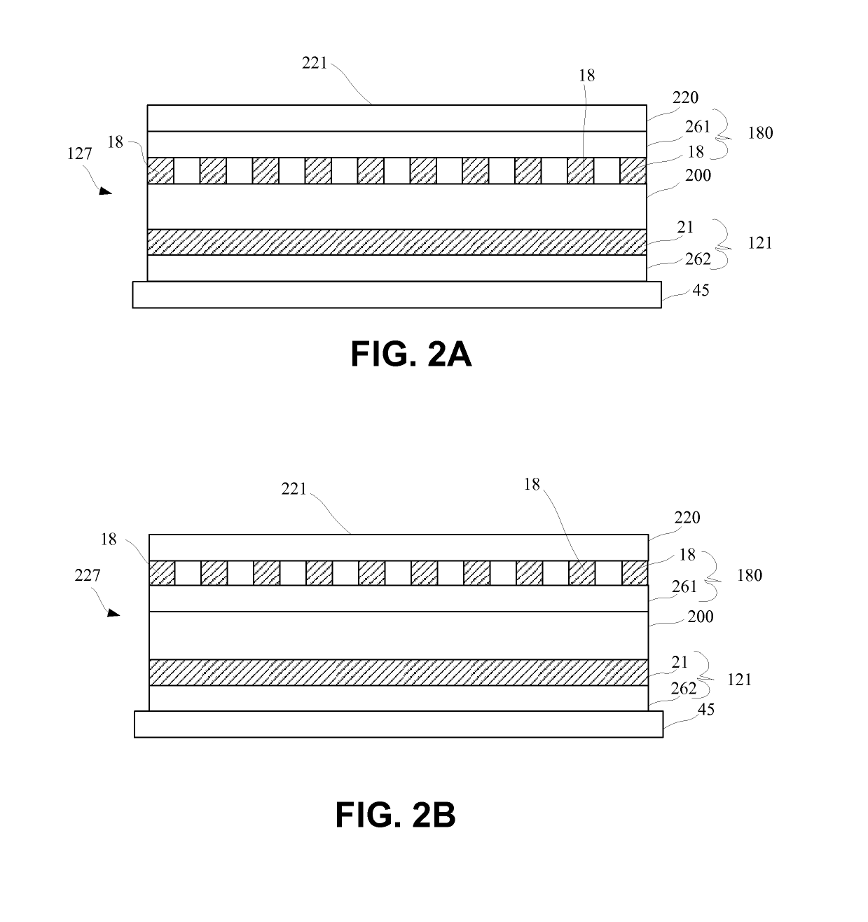

Reference is now made to FIGS. 2A, 2B and 2C showing simplified cross-sectional views of a three exemplary touch-screens with added resilient layer between sensing layers in accordance with some embodiments of the present invention. According to some embodiments of the present invention, capacitive sensors 127 and 227 are formed with a row layer 121 including a first substrate 262 patterned with row conductive lines 21, a column layer 180 including a second substrate 261 formed with column conductive lines 18, and a resilient layer 200 positioned in between the row and column layer. Typically, resilient layer 200 has a thickness of between 50-500 μm and is compressible. Optionally, the capacitive sensor, e.g. each of capacitive sensors 127 and 227 is part of a touch-screen and is overlaid on a FPD 45. In some exemplary embodiments, the capacitive sensor defines a sensing surface 221 over which a user interacts provides input, e.g. with a fingertip and/or stylus. Optionally, the capacitive sensor is covered with a protective layer 220 and sensing surface 221 is on the exposed surface of protective layer 220. According to some embodiments of the present invention, protective layer 220 is formed from a flexible material, e.g. PET film. It is noted that although row layer 121 is shown to be closer to FPD 45 and column layer 180 is shown to be closer to sensing surface 221, the opposite may be the case.

According to some embodiments of the present invention, resilient layer 200 is formed from a resilient material such as a silicone sheet, glue, gel, air and/or gas that compresses and/or deforms in response to pressure. Typically, resilient layer 200 is formed from non-conductive material. Typically, resilient layer 200 is formed from a transparent material, e.g. when used together with a touch screen. In some exemplary embodiments, resilient layer 200 is thicker than an adhesive layer that is typically used to bond layers of the capacitive sensor. Optionally, resilient layer 200 has a thickness between 50-500 μm, e.g. 50-200 μm or 100-300 μm. In some exemplary, resilient layer 200 is selected to have a hardness of between 20-70 shore A, e.g. 30 shore A. Typically, the material properties of resilient layer 200 are selected to disperse an effect of the touch over a desired number of junctions surrounding the junctions closest to where the user touched the sensor with the finger, hand, stylus or another object. According to some embodiments of the present invention, output from junctions surrounding a touch area is used to estimate and/or detect a pressure applied during the touch. According to some embodiments of the present invention, resilient layer 200 has a thickness of between 30-200 μm, e.g. 100 μm. Typically, the thickness is additionally and/or alternatively selected to provide a desirable feel for a user interacting with the capacitive sensor and also to provide a desired resolution for detecting pressure levels.

According to some embodiments of the present invention, row layer 121 and column layer 180 are stacked so that row conductive lines 21 face column conductive lines 18 and resilient layer 200 serves as the isolating layer between row conductive lines 21 and column conductive lines 18 (FIG. 2A). Typically, stacking the row layer and column layer so that row conductive lines 21 face column conductive lines 18, provides for maximizing the thickness of resilient layer 200 that can be used without diminishing and/or significantly diminishing the signal output obtained from capacitive sensor 127. Typically, proximity between the row and column layer is required to maintain a desired mutual capacitance between the layers. When positioning column layer 180 so that substrate 261 faces the sensing surface, conductive lines 18 are more distant from sensing surface 221. Optionally, the added distance from sensing surface 221 reduces sensitivity of capacitive sensor 127. Optionally, protective layer 220 is not used in the construction shown in FIG. 2A and/or is selected to be thin, to provide a desired proximity between conductive lines 18 and sensing surface 221. In some exemplary embodiments, layer 200 is glued between the row and column layer. Optionally, the glue layer is a thin layer of between 10-20 microns. Alternatively, resilient layer 200 has adhesive properties and is not required to be glued.

According to other embodiments of the present invention, row layer 121 and column layer 180 are stacked so that column conductive lines 18 face sensing surface 221 and resilient layer 200 is an additional layer that separates row and column layer (FIG. 2B). This construction provides for maintaining proximity of the column conductive lines to sensing surface 221 but limits a thickness that can be used for resilient layer 200 due to the thickness of substrate layer 261. In some exemplary embodiments, layer 200 is glued between the row and column layer. Optionally, the glue layer is a thin layer of between 10-150 μm and each of the sensing layers are approximately 100 μm. Alternatively, resilient layer 200 has adhesive properties and is not required to be glued.

According to some embodiments of the present invention, substrates 261 and 262 are formed from a PET foil or other foil that is flexible and/or can bend in response to pressure applied by a user, e.g. with a finger or stylus. Optionally, substrate 262 or other substrate positioned closer to FPD 45 is formed from a more rigid material such as glass. Optionally, row conductive lines 21 and column conductive lines 18 are formed with Indium Tin Oxide (ITO) or printed ink. It will be appreciated that multiple conductors similar or parallel to conductor 21 are patterned on substrate 262.

In some exemplary embodiments an adhesive layer is added between substrate 262 and FPD 45. Typically, when the capacitive sensor is used as part of a touch-screen, each of protective layer 200, row layer including a first substrate 262 patterned with row conductive lines 21, the column layer including a second substrate 261 formed with column conductive lines 18, resilient layer 200 is formed to be transparent to a user can viewing a display on FPD 45 through sensing surface 221.

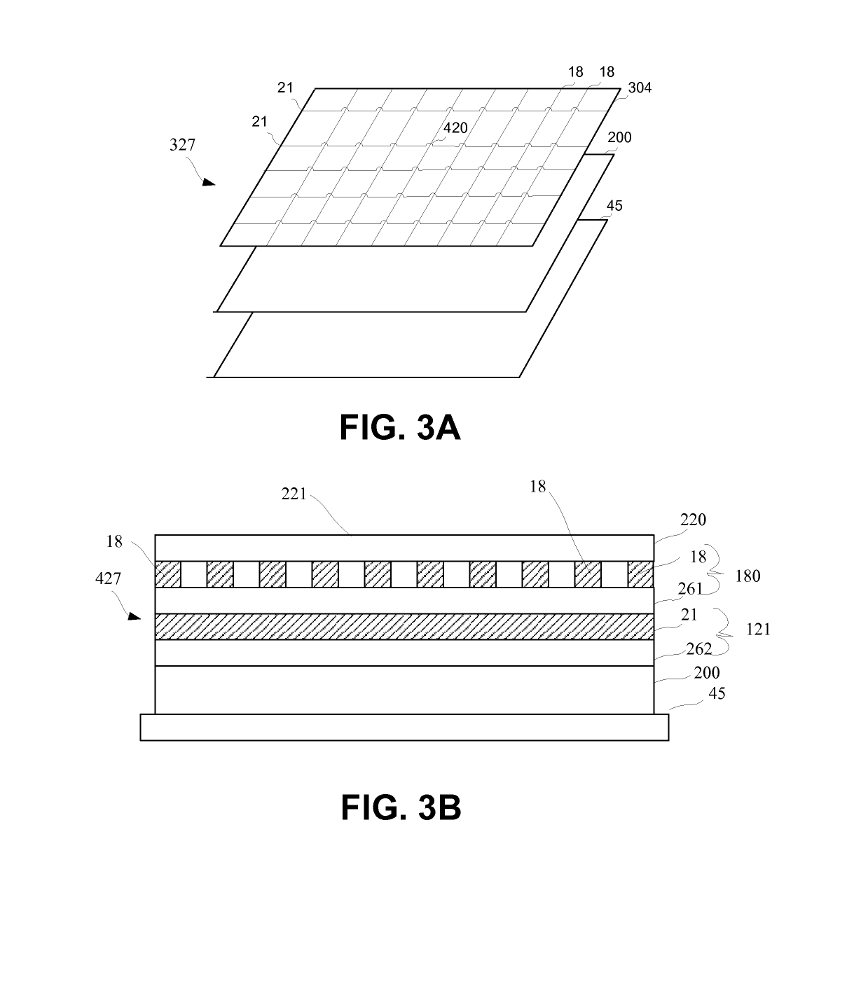

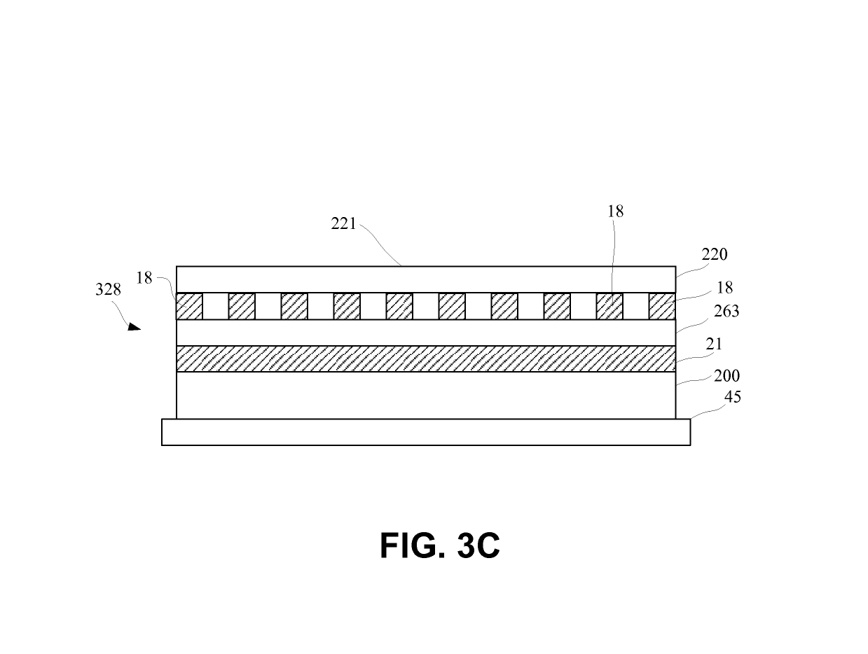

Reference is now made to FIGS. 3A, 3B and 3C showing a simplified exploded view and two simplified cross-section view respectively of three exemplary touch-screens with added resilient layer positioned between a capacitive sensor and an FPD of the touch-screen in accordance with some embodiments of the present invention. According to some embodiments of the present invention, resilient layer 200 is positioned between an FPD 45 of a touch-screen and sensing layer(s) of a capacitive sensor 327. In some exemplary embodiments, a capacitive sensor includes row conductive lines 21 and column conductive lines 18 pattern on a same surface of substrate 304 (FIG. 3A) and resilient layer 200 is positioned between substrate 304 and the FPD 45. Alternatively, resilient layer 200 is positioned between substrate 304 and a reference layer other than the FPD 45. Optionally, the reference layer is part of the capacitive sensor and acts as an electromagnetic shield. Typically, the reference layer is a conductive layer that is connected to ground and/or a reference voltage. Optionally, a protective layer that defines the sensing surface and/or interaction surface is added over the row conductive lines 18 and column conductive lines 21 (not shown here for clarity purposes). Typically, when a single substrate is used, jumpers 420 are used to provide isolation between the row and column conductive lines at junction locations.

In other embodiments of the present invention, a double substrate construction is used including column layer 180 and a row layer 121. In some exemplary embodiments, a touch-screen and/or capacitive sensor 327 or 427 is retrofitted with resilient layer 200 by adding resilient layer 200 between the FPD and sensing layer(s) of capacitive sensor 327 or 427. Optionally, resilient layer 200 is similar in construction to resilient layer 200 described in reference to FIGS. 2A-2B. According to some embodiments of the present invention, substrates 261 and 262 are formed from a PET foil or other foil that is flexible and/or can bend in response to pressure applied by a user, e.g. with a finger or stylus. Typically PET foil is not compressed, e.g. its thickness is not altered in response to applied pressure.

Referring now to FIG. 3C, according to some embodiments of the present invention, a capacitive sensor 328 includes row conductive lines 21 and column conductive lines 18 patterned on opposite surfaces of a same substrate 263 and a resilient layer 200 is added and/or positioned between substrate 263 and the FPD 45.

Optionally, maximum thickness of resilient layer 200 that can be used when positioned between FPD 45 and the sensing layer(s) of a capacitive sensor as shown in FIGS. 3A-3B is more than when positioning the resilient layer 200 between the sensing layers as shown in FIGS. 2A-2B. Optionally, when a thicker resilient layer 200 is desired a construction similar to that shown in FIGS. 3A, 3B and/or 3C is used.

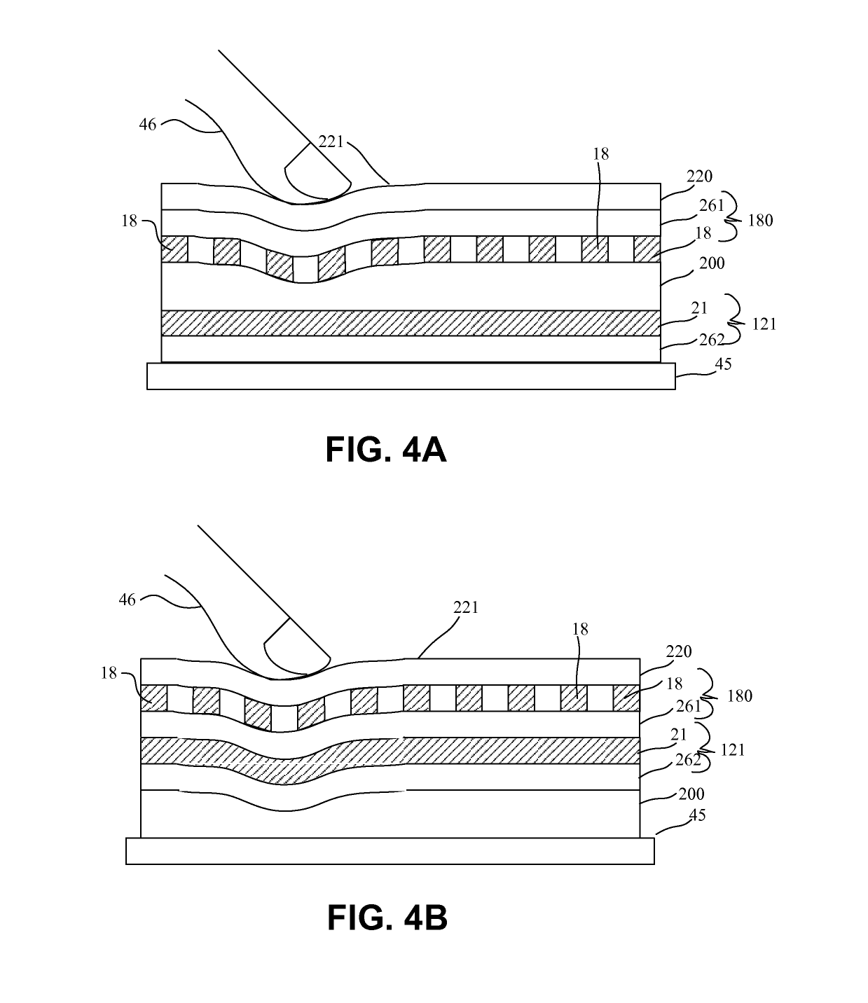

Reference is now made to FIGS. 4A and 4B showing simplified schematic illustrations of deformation due to fingertip touch in two exemplary touch-screens with added resilient layer in accordance with some embodiments of the present invention. According to some embodiments of the present invention, pressure applied by a fingertip 46 during touch and/or interaction with a touch-screen deforms layers of the capacitive sensor and compresses resilient layer 200. Typically, only the layers between resilient layer 220 and the fingertip 46, inclusive, are deformed and/or bent. In some exemplary embodiments, when resilient layer 200 is positioned between row layer 180 and column layer 210, only protective layer 220, and column layer 180 is deformed while resilient layer 200 absorbs the pressure and compresses. In alternate embodiments, when resilient layer is positioned between FPD 45 and the sensing layer(s), e.g. row layer 180 together with column layer 121, then protective layer 220, column layer 180, and row layer 121 are deformed. It is noted that for a capacitive sensor including row and column conductive lines patterned on opposite surfaces of a same substrate, the deformation of the sensing layers and the compression of the resilient layer will typically be similar to that shown in FIG. 4B. Although, depression and/or compression are shown in response to fingertip 46, a similar effect occurs in response to pressure applied by a stylus. Typically, the area deformed by a stylus is smaller than that of a fingertip since the dimensions of a fingertip are typically larger than that of a stylus tip. It is noted that although deformation along one axis of the capacitive sensor is shown, typically the deformation occurs along both the row and column axis of the capacitive sensor.

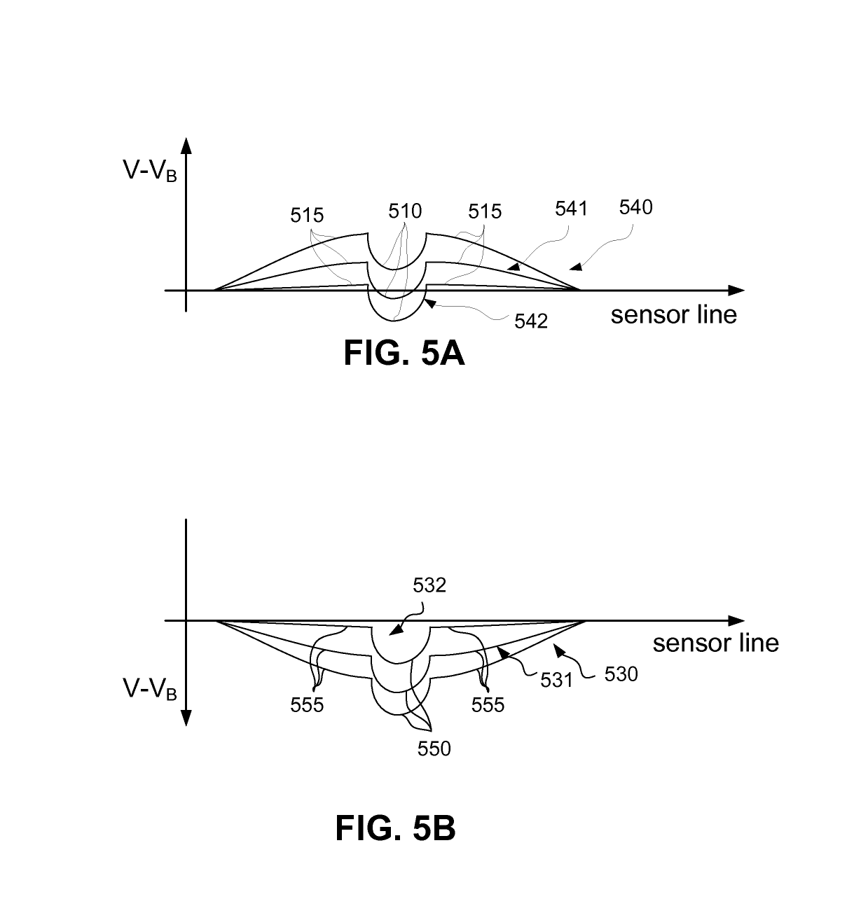

Reference is now made to FIG. 5A showing simplified graphs of exemplary output obtained from a capacitive sensor including a resilient layer between a row layer and column layer of a mutual capacitive sensor (FIGS. 2A and 2B and FIG. 4A) in accordance with some embodiments of the present invention. FIG. 5A shows three exemplary graphs for different pressure levels applied on the capacitive sensor. Graph 540 represents output when maximum pressure is applied at a touch location, 541 represents output when medium pressure is applied at same touch location, and 542 represents output when low pressure is applied at same touch location. Typically, amplitude and extent of output decreases for lower levels of pressure.

According to some embodiments of the present invention, when a resilient layer is positioned between the row and column conductive layer, pressure applied by a fingertip on the touch-screen increases the proximity between the row and column conductive layer and thereby increases the mutual capacitance in that area. Typically, increased mutual capacitance increases the signal measured in a conductive line in relation to the baseline voltage V_{B}. Baseline voltage is defined as the voltage measured when there is no object, e.g. fingertip, conductive object or signal transmitting stylus present on or near the conductive lines. Typically, capacitive coupling in response to a presence of a fingertip or other conductive objects has an opposite effect. Typically, a presence of a fingertip reduces the mutual capacitance of the capacitive sensor in the area of touch. Typically, decreased mutual capacitance decreases the signal measured in a conductive line in relation to the baseline voltage V_{B}.

The present inventor has found that the affect of coupling between a fingertip and the capacitive sensor is typically more localized and more pronounced than the changes in mutual capacitance due to compression of the resilient layer. As such, location profile 510 is typically a steeper peak, e.g. negative peak that is more localized around a touch area as compared to pressure profile 515. It is noted that each of graphs 540, 541 and 542 are summations of the pressure profile and the location profile for a given touch. Typically, the location profile 510 is substantially or somewhat stable over different pressures applied during the touch interaction but may be altered by some degree.

According to some embodiments of the present invention, amplitude and/or gradient of pressure profile 515 appearing on either side of location profile 510 is used to determine a pressure level applied by a conductive object such as a fingertip. According to some exemplary embodiment, either one or both of pressure profile 515 and location profile 510 are used for determining touch location of the conductive object. It will be appreciated that when the user touches the sensor with multiple fingers which may be close to each other, the corresponding pressure profiles may overlap, but would still provide indications to junctions in which the capacitance is reduced relatively to their neighboring junctions.

It is noted that the graphs represent output from an array of conductive lines along one axis of a mutual capacitance sensor and represent output along an array of junctions formed between a conductive line that were interrogated and crossing conductive lines. The output is shown as a continuous line for convenience. Typically, similar pressure profiles and location profiles are obtained from conductive lines along the other axis of a mutual capacitance.

Reference is now made to FIG. 5B showing simplified graphs of exemplary output obtained from a capacitive sensor including a resilient layer between an FPD or reference layer and sensing layer(s) of a mutual capacitive sensor as shown FIGS. 3A and 3B and FIG. 4B in accordance with some embodiments of the present invention. FIG. 5B shows three exemplary graphs for different pressure levels applied on the capacitive sensor. Graph 530 is an exemplary summation of a pressure profile and location profile obtained when maximum pressure is applied. Typically, amplitude, e.g. amplitude of negative peak and spread of the pressure profile decreases as the applied pressure is decreased. It is noted that the graphs represent output from an array of conductive lines along one axis of a mutual capacitance sensor, and represent output along an array of junctions formed between an interrogated conductive line and crossing conductive lines. The output is shown as a continuous line for convenience. Typically, similar pressure profiles and location profiles are obtained from conductive lines along the other axis of a mutual capacitance.

According to some embodiments of the present invention, when a resilient layer is positioned between the FPD and the sensing layer(s) of the capacitive sensor, pressure applied on the touch-screen, increases the proximity between the conductive lines of the sensor and a FPD that is typically connected to a reference voltage or a ground, which decreases the mutual capacitance in that area. Typically, decreased mutual capacitance decreases the signal measured in a conductive line in relation to the baseline voltage V_{B} that is typically measured when there is no interaction near the conductive lines. Typically, signal 555 detected responsive to pressure applied on the touch-screen is detected on conductive lines surrounding a touch area, while signal 550 detected responsive to changes in capacity induced by a presence of a conductive object, e.g. fingertip is localized in the area of the touch. Typically, a presence of a fingertip further reduces the mutual capacitance between the row and column conductive lines, and therefore signal 550 further decreases at or near the point touched by the conductive object, relatively to the signal 555 sensed responsive to pressure applied on the capacitive sensor. According to some embodiments of the present invention, amplitude of signal 555 on either side of signal 550 is used to determine a pressure level applied by a conductive object such as a fingertip.

It is noted that the output obtained from the capacitive sensor is a combination of output responsive to applied pressure, e.g. the pressure profile and output responsive to a presence of a conductive object, e.g. the location profile. According to some exemplary embodiment, curve 555 and/or are used for determining the exact touch location of the conductive object. It will be appreciated that when the user touches the sensor with multiple fingers which may be close to each other, the received graph shape may change, but would still provide indications to junctions in which the capacitance is reduced relatively to their neighboring junctions.

It is noted that the graphs of FIGS. 5A and 5B can represent output obtained in the frequency used to interrogate the capacitive sensor and/or in a selected frequency within the frequency band used for triggering.

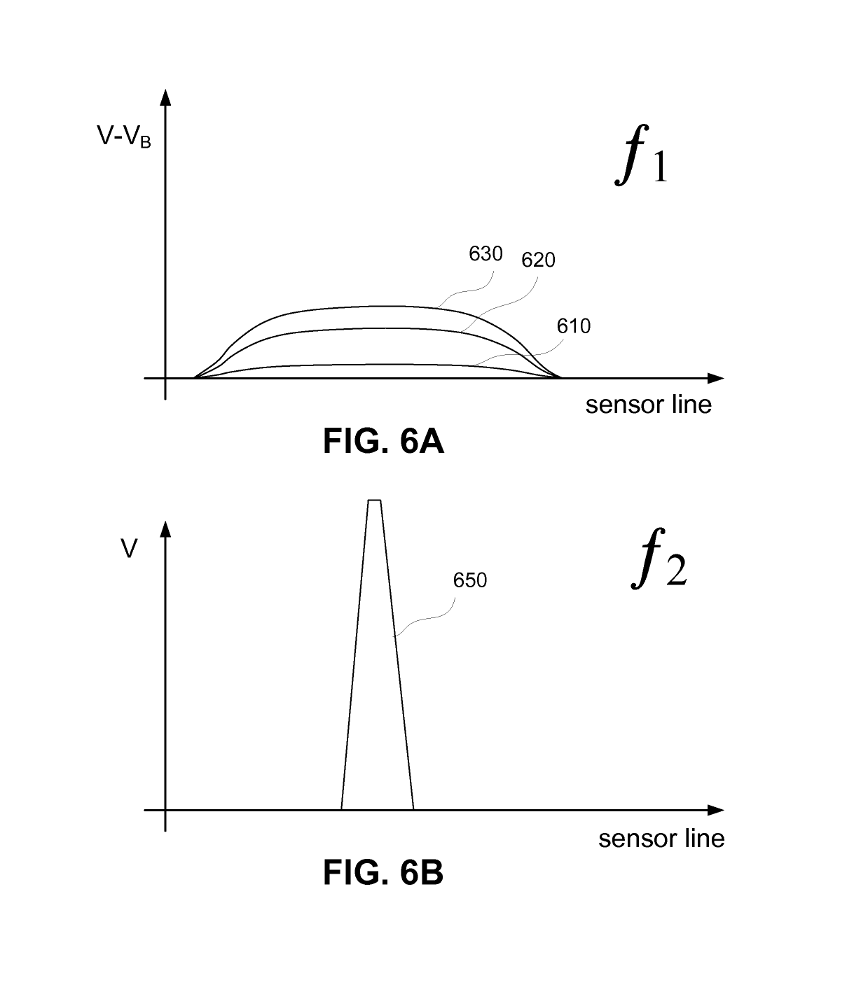

Reference is now made to FIGS. 6A and 6B showing simplified graphs of exemplary output in two different frequency, respectfully, in response to touch with a signal transmitting stylus in accordance with some embodiments of the present invention. According to some embodiments of the present invention, output due to pressure applied on the capacitive sensor is detected in response to scanning the capacitive sensor with an interrogation signal. Typically, output related to pressure, e.g. the pressure profile is detected in the frequency band of the interrogation signal. FIG. 6A shows three exemplary pressure profiles from capacitive sensor detected in a frequency f₁. The three exemplary graphs represent exemplary output obtained from three different pressure levels applied on the capacitive sensor. Graph 630 represents exemplary output obtained when an object, e.g. a signal transmitting stylus applies high pressure during touch, graph 620 represents exemplary output obtained when an object applies a medium pressure during touch and graph 610 represents exemplary output obtained when an object applies a relatively small level of pressure during touch. Typically, the pressure profiles are obtained from conductive lines near a touch location. Typically, the peak output in each graph is obtained from a conductive line closest to the touch location.

According to some embodiments of the present invention, a signal transmitting stylus emits a signal in a frequency f₂ that is distanced from frequency f₁ or at a different timing. FIG. 6B shows an exemplary graph of output obtained from a capacitive sensor in response to a presence of a stylus that emits a signal in frequency f₂. Optionally, the graph of FIG. 6B is obtained at a different time than the graph of FIG. 6A. Typically, amplitude of output responsive to picking up a signal emitted from the stylus is significantly larger than amplitude of output responsive to pressure applied by the stylus tip (FIG. 6A). Typically, each of pressure profiles 610, 620 or 630 responsive to pressure applied by the stylus tip is concentric with location profile 650 responsive to detection of a signal emitted by the stylus. Alternatively, for cases when the signal from the stylus is emitted at a location away from the stylus tip, the output responsive to pressure applied by the stylus tip will not be concentric with the output responsive to the signal picked up from the stylus. Optionally, when output is examined over a wide frequency band including both the frequency of the stylus and the interrogation frequency, output from the capacitive sensor will be a summation of a pressure profile, e.g. graph 610, 620 or 630 and location profile 650.

In some exemplary embodiments, when a signal emitted by the stylus is transmitted from a position away from the tip, location of the tip can be determined from the pressure profiles, and/or an orientation of the stylus can be determined from the tip position as detected from the pressure profile and the signal pick up position as detected from the location profile.

It is noted that FIG. 6A represents a pressure profile for a capacitive sensor including a resilient layer added between sensing layers. Alternatively, pressure profiles showing a decrease in output in response to applied pressure (as shown in FIG. 5B) are obtained for a capacitive sensor including the resilient layer between the sensing layer(s) and the FPD.

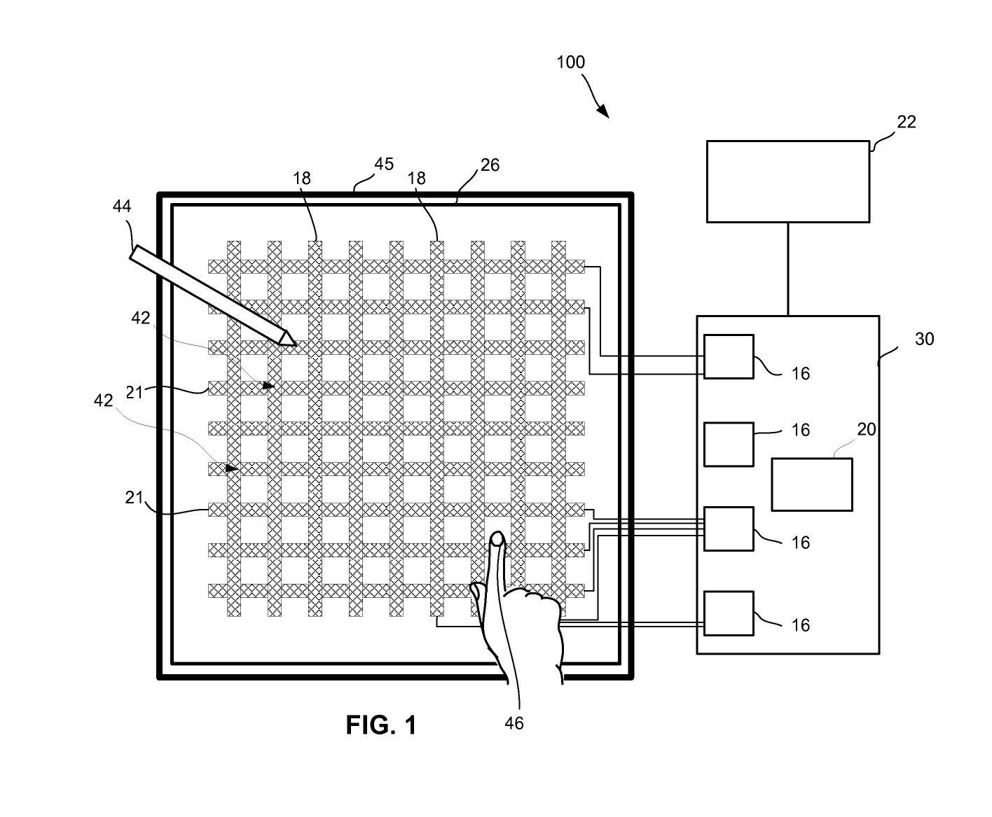

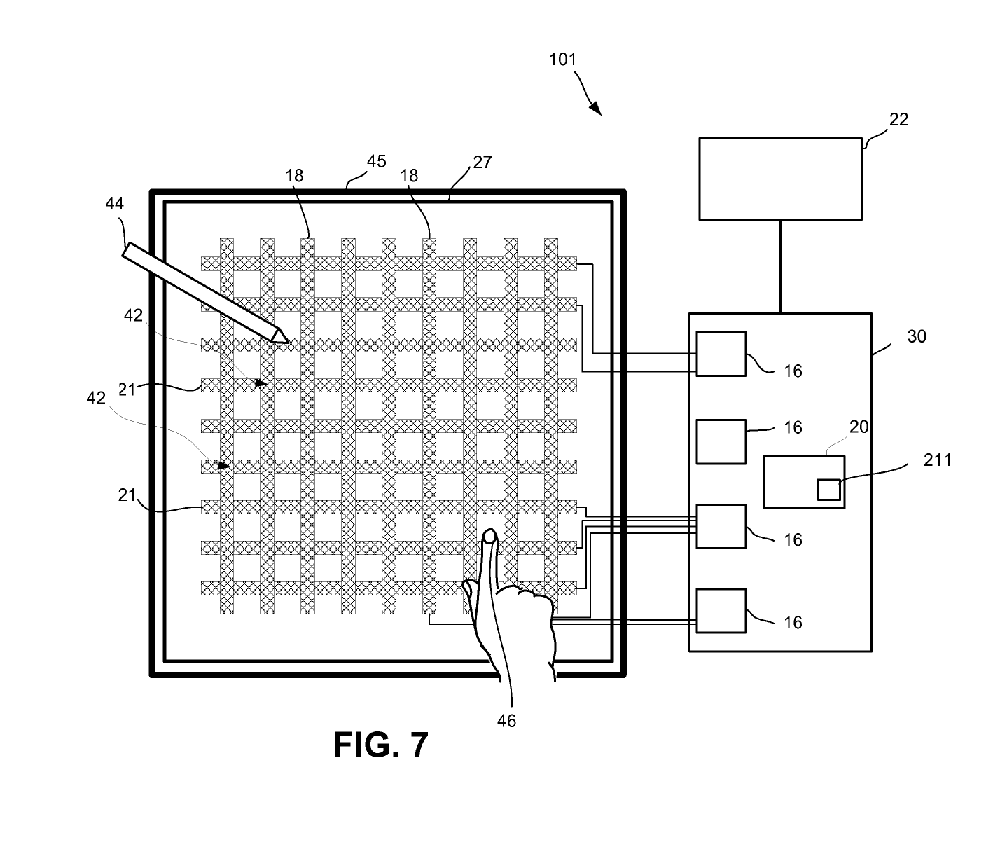

Reference is now made to FIG. 7 showing a simplified block diagram of an exemplary touch-screen in accordance with some embodiments of the present invention. Some of the features of touch-screen 101 are similar to those of touch-screen 100 (FIG. 1) and those features are marked with the same reference numbers. According to some embodiments of the present invention, capacitive sensor 27 is a mutual capacitive type sensor that includes an additional resilient layer positioned between sensing layers of the capacitive sensor and/or between FPD 45 (or other reference layer) and the sensing layer(s) of capacitive sensor 27. According to some embodiment of the present invention, one or more conductive lines in one axis of sensor 27, e.g. row conductive lines 21 or column conductive lines 18 are triggered and in response output from capacitive sensor is sampled by one or more ASICs 16. According to some embodiments of the present invention, digital unit 20 includes a pressure detecting engine 211 that is adapted to identify pressure profiles surrounding touch locations and to determine a pressure level associated with a touch location. Optionally, touch location and applied pressure are forwarded to host 22. Alternatively, pressure detecting engine 211 is included as part of host 22 and digital unit 20 forwards output sampled to host 22 for analysis. Optionally, output is in the form of a topographic map of the output obtained across the sensing area of the capacitive sensor.

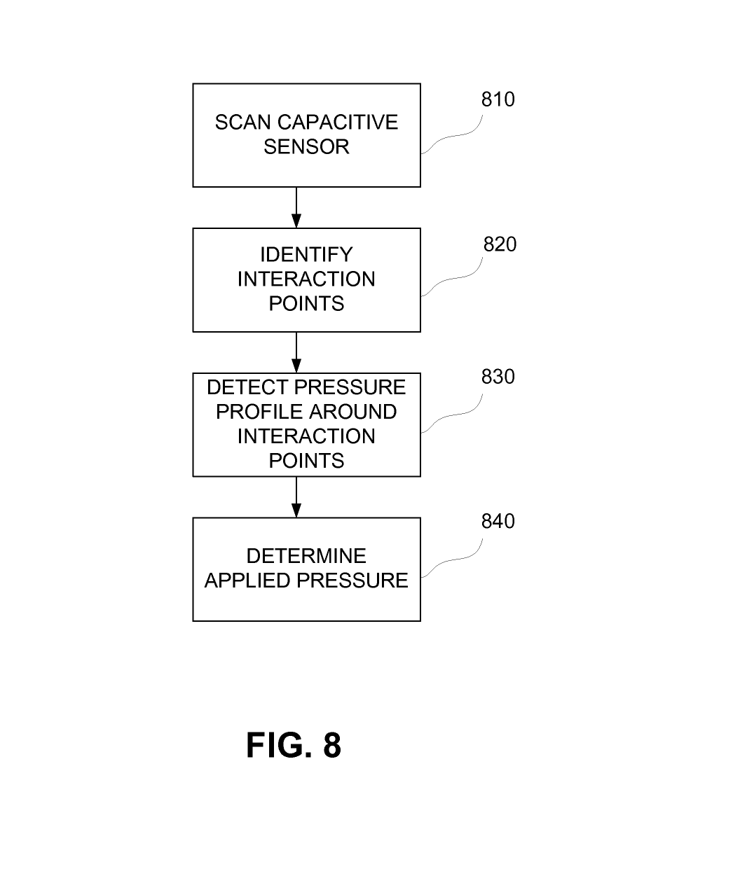

Reference is now made to FIG. 8 showing a simplified flow chart of an exemplary method for detecting pressure applied at interaction points on a mutual capacitive sensor in accordance with some embodiments of the present invention. According to some embodiments of the present invention, a mutual capacitive sensor is scanned to obtain output from a plurality of junctions of the capacitive sensor (block 810). According to some embodiments of the present invention, one or more interaction points are identified from the output detected (block 820). Typically, an interaction point obtained from conductive object such as a fingertip is identified as a negative peak and/or a trough spreading across a plurality of junctions. Typically, interaction points obtained from a signal transmitting device, e.g. a stylus, is identified as a positive peak spreading across a plurality of junctions. Typically, stylus location can be determined without requiring scanning. According to some embodiments of the present invention, one or more pressure profiles are identified. Typically, pressure profiles are detected around a touch location (block 830). Optionally, touch location and pressure profiles are detected in different time frames, e.g. responsive to detecting stylus input. According to some embodiments of the present invention, pressure applied in an area of interaction is determined from the gradient, amplitude and/or spread of the pressure profiles (block 840). Optionally, a relationship between applied pressure, amplitude and spread of a pressure profile is defined based on empirical data. Optionally, a conversion table and/or formula stored in memory of the digitizer system are used to convert gradient, amplitude and/or spread of a pressure profile to a pressure level. Optionally, applied pressure is identified as one of low, medium or high pressure. Optionally, pressure level is detected with higher resolution based on the pressure profiles.

It is noted that although most of the embodiments of the present invention have been described in reference to an arrangement of evenly spaced, vertical and horizontal conductive lines, embodiments of the disclosure are not limited by the placement or arrangement of conductive lines. Optionally, conductive lines and junctions formed between conductive lines may be arranged to enable different sensitivities and/or resolutions for respective different regions of the capacitive sensor.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

What is claimed is:

1. A pressure sensitive capacitive sensor for a digitizer system, the capacitive sensor comprising:
an interaction surface over which a user interacts with the capacitive sensor;
at least one sensing layer operable to sense interaction by mutual capacitive sensing, the at least one sensing layer extending across the interaction surface, wherein the at least one sensing layer is patterned with row and column sensing strips arranged in a grid; and
an additional layer comprising resilient properties and operable to be locally compressed responsive to pressure locally applied on the interaction surface during user interaction with the capacitive sensor.

2. The capacitive sensor according to claim 1 wherein the additional layer is selected to have a hardness of between 20-70 shore A and thickness of between 50-500 μm.

3. The capacitive sensor according to claim 1, comprising a protective layer, wherein the interaction surface is a surface of the protective layer, wherein the protective layer is formed from flexible material that is operable to bend responsive to pressure locally applied on the interaction surface.

4. The capacitive sensor according to claim 1, comprising a rigid layer, wherein the rigid layer is positioned distal from the interaction surface and wherein the additional layer is positioned between the rigid layer and the at least one sensing layer.

5. The capacitive sensor according to claim 4, wherein the rigid layer is formed from a glass substrate.

6. The capacitive sensor according to claim 1, comprising a reference layer, wherein the reference layer is conductive and is connected to ground or to a reference voltage, and wherein the additional layer is positioned between the at least one sensing layer and the reference layer.

7. The capacitive sensor according to claim 1, wherein the at least one sensing layer is a single sensing layer and wherein the single sensing layer is formed with a flexible that is operable to bend responsive to pressure locally applied on the interaction surface.

8. The capacitive sensor according to claim 1, wherein the at least one sensing layer includes a first sensing layer patterned with row conductive strips and a second sensing layer patterned with column conductive strips and wherein the additional layer is positioned between the first sensing layer and the second sensing layer.

9. The capacitive sensor according to claim 8, wherein at least one of the first and second sensing layers is formed with a flexible material and is operable to bend responsive to pressure locally applied on the interaction surface.

10. The capacitive sensor according to claim 9, wherein the additional layer is operative to provide for locally reducing distance between the first and second sensing layer, wherein the reducing is responsive to the applied pressure during the interaction.

11. The capacitive sensor according to claim 1, wherein the at least sensing layer of the capacitive sensor is retrofitted with the additional layer.

12. The capacitive sensor according to claim 1, wherein the additional layer is formed from a transparent material that is non-conductive.

13. A digitizer system comprising:
a capacitive sensor according to any one of claim 1, and
circuitry electrically connected to the capacitive sensor, wherein the circuitry is adapted for detecting output from the capacitive sensor and for determining both location of an interaction and pressure applied at the interaction location responsive to the output.

14. A pressure sensitive touch screen comprising:
an interaction surface over which a user interacts with the touch screen;
at least one sensing layer operable to sense interaction by mutual capacitive sensing, the at least one sensing layer extending across the interaction surface, wherein the at least one sensing layer is patterned with row and column sensing strips arranged in a grid;
an additional layer comprising resilient properties and operable to be locally compressed responsive to pressure locally applied on the interaction surface; and
a flat panel display.

15. The touch screen according to claim 14 wherein the additional layer is selected to have a hardness of between 20-70 shore A and thickness of between 50-500 μm.

16. The touch screen according to claim 14, wherein the interaction surface is formed by a protective layer positioned over the at least one sensing layer, wherein the protective layer is formed from flexible material that is operable to bend to responsive to pressure locally applied on the interaction surface.

17. The touch screen according to claim 14, wherein the additional layer is positioned between the at least one sensing layer and the flat panel display.

18. The touch screen according to claim 14, comprising a reference layer, wherein the reference layer is conductive and is connected to ground or to a reference voltage and wherein the additional layer is positioned between the at least one sensing layer and the reference layer.

19. The touch screen according to claim 14, wherein the touch screen is retrofitted with the additional layer.

20. A method for sensing applied pressure with a capacitive sensor that includes a resilient layer, the method comprising:
scan output from a capacitive sensor;
identify an interaction point;
detect pressure profile around the interaction point; and
determine pressure applied at the interaction point responsive to a feature of the detected pressure profile.

21. The method according to claim 20, wherein the feature is a gradient of the pressure profile around the interaction point.

22. The method according to claim 20, wherein the pressure profile is detected in a frequency band used to interrogate the capacitive sensor during scanning.

23. The method according to claim 20, wherein the interaction point is responsive to touch by at least one of a fingertip and stylus.

24. The method according to claim 20, wherein the pressure profile and the location of the interaction points are detected in different time frames.
